(19) United States
(12) Patent Application Publication
(10) Pub. No.: US 2026/0274734 A1
(43) Pub. Date: Sep. 17, 2026

(54) GLASS PLATE MANUFACTURING METHOD AND MANUFACTURING APPARATUS

(71) Applicant: Nippon Electric Glass Co., Ltd., Shiga (JP)

(72) Inventors: Masayoshi YAMAMOTO, Shiga (JP); Hideki TANABE, Shiga (JP)

(21) Appl. No.: 19/167,540

(22) PCT Filed: Apr. 11, 2024
(86) PCT No.: PCT/JP2024/014709

§ 371 Date: Sep. 22, 2025

(30) Foreign Application Priority Data
Apr. 28, 2023 (JP) 2023-074331

(51) Int. Cl. C03B 23/031; C03B 33/02

(52) U.S. Cl. CPC C03B 23/031; C03B 33/0207

(57) ABSTRACT

Provided is a manufacturing method for a glass sheet, the method including a breaking step (P2) of breaking a glass sheet (G) being in a vertical orientation and having a scribe line(S) formed on a front surface (Ga) and extending in a vertical direction, to separate a first region (G1) and a second region (G2) which are adjacent to each other in a horizontal direction across the scribe line(S) as a boundary. The method further includes a preparation step (P1) of curving the glass sheet (G) before breaking such that the front surface (Ga) is shaped into a convex curved surface in a cross section parallel to the horizontal direction. After the preparation step (P1), the breaking step (P2) is conducted on the glass sheet (G) in a curved state.

### TECHNICAL FIELD

The present disclosure relates to a technology for breaking a glass sheet in a vertical orientation along a scribe line extending in a vertical direction.

### Background Art

As a technique for manufacturing a glass sheet, there is a technique using a down-draw method such as an overflow down-draw method, a slot down-draw method, and a redraw method. As one example of a manufacturing process for a glass sheet using the above-mentioned technique, a manufacturing process as described below is given.

First, a glass ribbon is continuously formed from a molten glass. At this time, portions referred to as “thickened edge portions”, each having a larger thickness as compared to a middle portion, are formed as both end portions of the glass ribbon in a width direction. Next, the glass ribbon is cut in the width direction into pieces, each having a predetermined length, to thereby successively cut out glass sheets, which serve as mother glass sheets for product glass sheets, from the glass ribbon. Next, unnecessary portions including the thickened edge portions (non-product portions) are trimmed off from the cut-out glass sheet. After that, various steps such as grinding, polishing, and a cleaning treatment are performed on the glass sheet from which the unnecessary portions have been removed to thereby manufacture a product glass sheet.

When the glass sheet is manufactured by using the down-draw method, the glass ribbon, which has been obtained by forming, has a vertical orientation. Thus, in view of, for example, saving space in a plane direction, the glass sheet, which has been cut out from the glass ribbon in a vertical orientation, may be conveyed while keeping its vertical orientation and the unnecessary portions may be trimmed off from the glass sheet in a conveyance path. In Patent Literature 1, there is disclosed a manufacturing process in which the unnecessary portions are removed in the above-mentioned manner.

In the manufacturing process disclosed in Patent Literature 1, first, the glass sheet in a vertical orientation is conveyed in a horizontal direction into a scribe-line formation area in the conveyance path. Then, a scribe line is formed on a front surface of the glass sheet in a vertical direction. After that, a back-surface support member is brought into contact with a back surface of the glass sheet on a downstream side of the scribe-line formation area, and an area around the scribe line is curved by using the back-surface support member as a fulcrum so that a front surface side is shaped convex. The glass sheet is broken along the scribe line to remove the unnecessary portion.

### CITATION LIST

Patent Literature 1: WO 2022/219922 A1

### SUMMARY OF INVENTION

### Technical Problem

As in the manufacturing process disclosed in Patent Literature 1, when the glass sheet in a vertical orientation is broken, end-surface properties may be unsatisfactory due to, for example, glass chipping or a large number of microcracks, which are observed on end surfaces of the glass sheet after breaking. A technical object to be achieved in view of the circumstances described above is, when a glass sheet in a vertical orientation is broken along a scribe line extending in a vertical direction, to improve end-surface properties of the glass sheet after breaking.

### Solution to Problem

As a result of intensive studies, the inventors have found that, when a glass sheet in a vertical orientation is broken along a scribe line extending in a vertical direction, an element affecting end-surface properties of the glass sheet after breaking is a curved state of the glass sheet in a cross section parallel to a horizontal direction. More specifically, the inventors have found that, when breaking is performed under a state in which a surface of the glass sheet on which the scribe line is formed is a concave curved surface in the cross section parallel to the horizontal direction due to, for example, a warp of the glass sheet, the end-surface properties are unsatisfactory. This is due to an unstable contact state between a member serving as a fulcrum for curving the glass sheet at the time of breaking (back-surface support member in Patent Literature 1) and the glass sheet. Further, the inventors have found that, when breaking is performed under a state in which the surface of the glass sheet on which the scribe line is formed is a convex curved surface in the cross section parallel to the horizontal direction, the contact state between the above-mentioned member serving as a fulcrum and the glass sheet is stabilized, resulting in satisfactory end-surface properties.

Based on the above-mentioned findings, in order to achieve the object described above, there is provided a first manufacturing method for a glass sheet, the method comprising a breaking step of breaking the glass sheet being in a vertical orientation and having a scribe line formed on a front surface and extending in a vertical direction, to separate a first region and a second region which are adjacent to each other in a horizontal direction across the scribe line as a boundary. The method further comprises a preparation step of curving the glass sheet before breaking such that the front surface is shaped into a convex curved surface in a cross section parallel to the horizontal direction. After the preparation step, the breaking step is conducted on the glass sheet in a curved state.

In the first manufacturing method for a glass sheet, for breaking the glass sheet in a vertical orientation along the scribe line extending in the vertical direction, the preparation step is conducted. In the preparation step, the glass sheet before breaking is curved such that the front surface is shaped into the convex curved surface in the cross section parallel to the horizontal direction. As described above, in this manufacturing method, after the surface on which the scribe line is formed (front surface) is shaped into a convex curved surface in the cross section parallel to the horizontal direction in the preparation step, the breaking step is conducted to break the glass sheet. Thus, the contact state between the member serving as a fulcrum for curving the area around the scribe line on the glass sheet and the glass sheet is stabilized at the time of breaking, enabling improvement of the end-surface properties of the glass sheet after breaking.

There is provided a second manufacturing method for a glass sheet in which, in the above-mentioned first manufacturing method for a glass sheet, in the preparation step, the glass sheet is pressed from a back surface side by a pressing member.

In the second manufacturing method for a glass sheet, the glass sheet is pressed from the back surface side by the pressing member in the preparation step. Thus, a state in which the surface of the glass sheet on which the scribe line is formed (front surface) is a convex curved surface in the cross section parallel to the horizontal direction can be smoothly and reliably achieved.

There is provided a third manufacturing method for a glass sheet in which, in the above-mentioned second manufacturing method for a glass sheet, the glass sheet has the second regions on both sides of the first region in the horizontal direction, and the preparation step comprises: holding an upper part of the glass sheet with a holding member so that the glass sheet is suspended; and pressing a lower part of the first region with the pressing member.

In the third manufacturing method for a glass sheet, the lower part of the first region of the glass sheet suspended by the holding member is placed in a state of being pressed by the pressing member in the preparation step before breaking of the glass sheet. When the lower part of the first region is pressed by the pressing member as described above, generation of vibrations propagating from the lower part of the glass sheet at the time of breaking, and in turn, destabilization of breaking due to the vibrations can be prevented.

There is provided a fourth manufacturing method for a glass sheet in which, in the above-mentioned third manufacturing method for a glass sheet, the first region comprises: a usable portion that is to become a product; and an unusable portion that is to become a non-product, and in the preparation step, the pressing member is brought into contact with only the unusable portion out of the usable portion and the unusable portion.

In the fourth manufacturing method for a glass sheet, the pressing member is brought into contact with only the unusable portion, which is to become a non-product, out of the usable portion and the unusable portion of the first region of the glass sheet, in the preparation step. Thus, the pressing member is not brought into contact with the usable portion, which is to become a product. As a result, a scratch on the usable portion or contamination of the usable portion can be suitably prevented, enabling protection of the usable portion.

There is provided a fifth manufacturing method for a glass sheet in which, in the above-mentioned third or fourth manufacturing method for a glass sheet, in the preparation step, while causing support members to support one end portion and the other end portion of the first region in the horizontal direction from both front and back sides, and while causing the pressing member to press the lower part of the first region between the support members that support the one end portion and the other end portion, an operation in which the support members support the first region and an operation in which the pressing member presses the first region are synchronized.

In the fifth manufacturing method for a glass sheet, the operation in which the support members support the first region and the operation in which the pressing member presses the first region are synchronized in the preparation step. Thus, a timing at which the support members and the pressing member are operated is fixed. As a result of fixing the timing operations as described above, a timing at which the pressing member is brought into contact with the first region can easily be adjusted by only adjusting, for example, a relative positional relationship between the support members and the pressing member.

There is provided a sixth manufacturing method for a glass sheet in which, in any one of the above-mentioned second to fifth manufacturing methods for a glass sheet, the pressing member extends in the horizontal direction, and with respect to a contact portion of the pressing member that contacts the glass sheet, a curvature of the contact portion in the cross section parallel to the horizontal direction is adjustable.

In the sixth manufacturing method for a glass sheet, the curvature of the contact portion of the pressing member can be adjusted. Thus, a curvature of the front surface of the glass sheet, which has been shaped into a convex curved surface, can easily be changed.

There is provided a seventh manufacturing method for a glass sheet in which, in any one of the above-mentioned first to sixth manufacturing methods for a glass sheet, in the preparation step, the glass sheet before breaking is curved such that the front surface is shaped into a convex curved surface in a cross section parallel to the vertical direction.

In the seventh manufacturing method for a glass sheet, the surface on which the scribe line is formed (front surface) is shaped into a convex curved surface in the cross section parallel to the vertical direction as a result of the preparation step. Thus, a point at which breaking is started in the breaking step can be stabilized in the vicinity of a center of the glass sheet in the vertical direction.

Based on the above-mentioned findings, in order to achieve the object described above, there is provided an eighth manufacturing method for a glass sheet, the method comprising a breaking step of breaking the glass sheet being in a vertical orientation and having a scribe line formed on a front surface and extending in a vertical direction, to separate a first region and a second region which are adjacent to each other in a horizontal direction across the scribe line as a boundary. The glass sheet has the second regions on both sides of the first region in the horizontal direction. The manufacturing method further comprises a preparation step of achieving a state ready for breaking the glass sheet, the preparation step being followed by the breaking step conducted on the glass sheet in a curved state. In the preparation step, an upper part of the glass sheet is held by a holding member so that the glass sheet is suspended, and a lower part of the first region is pressed from a back surface side by a pressing member.

In the eighth manufacturing method for a glass sheet, for breaking the glass sheet in a vertical orientation along the scribe line extending in the vertical direction, the preparation step of pressing, from the back surface side, the lower part of the first region of the glass sheet suspended by the holding member is conducted before breaking. The surface on which the scribe line is formed (front surface) can be shaped into a convex curved surface in the cross section parallel to the horizontal direction, by pressing, from the back surface side, the lower part of the first region positioned between the second regions on both sides in the horizontal direction as described above. The glass sheet can be broken by subsequently conducting the breaking step. Thus, the contact state between the member serving as a fulcrum for curving the area around the scribe line on the glass sheet and the glass sheet is stabilized at the time of breaking, enabling improvement of the end-surface properties of the glass sheet after breaking. Further, in this manufacturing method, the lower part of the first region of the glass sheet is placed in a state of being pressed by the pressing member in the preparation step before breaking of the glass sheet. When the lower part of the first region is pressed by the pressing member as described above, generation of vibrations propagating from the lower part of the glass sheet at the time of breaking, and in turn, destabilization of breaking due to the vibrations can be prevented.

Based on the above-mentioned findings, in order to achieve the object described above, there is provided a first manufacturing apparatus for a glass sheet, the manufacturing apparatus comprising a breaking mechanism configured to break the glass sheet being in a vertical orientation and having a scribe line formed on a front surface and extending in a vertical direction, to separate a first region and a second region which are adjacent to each other in a horizontal direction across the scribe line as a boundary. The breaking mechanism comprises a curving mechanism configured to curve the glass sheet before breaking such that the front surface is shaped into a convex curved surface in a cross section parallel to the horizontal direction.

The first manufacturing apparatus for a glass sheet enables the same functions and effects as those obtained with the above-mentioned first manufacturing method for a glass sheet, to be obtained.

Based on the above-mentioned findings, in order to achieve the object described above, there is provided a second manufacturing apparatus for a glass sheet, the manufacturing apparatus comprising a breaking mechanism configured to break the glass sheet being in a vertical orientation and having a scribe line formed on a front surface and extending in a vertical direction to separate a first region and a second region which are adjacent to each other in a horizontal direction across the scribe line as a boundary. The glass sheet has the second regions on both sides of the first region in the horizontal direction. The breaking mechanism comprises: a holding member configured to hold an upper part of the glass sheet to suspend the glass sheet; and a pressing member configured to press a lower part of the first region from a back surface side.

The second manufacturing apparatus for a glass sheet enables the same functions and effects as those obtained with the above-mentioned eighth manufacturing method for a glass sheet, to be obtained.

### Advantageous Effects of Invention

According to the manufacturing method and the manufacturing apparatus for a glass sheet of the present disclosure, it is possible to improve the end-surface properties of the glass sheet after breaking when the glass sheet in the vertical orientation is broken along the scribe line extending in the vertical direction.

### BRIEF DESCRIPTION OF DRAWINGS

FIG. 1 is a front view for illustrating a manufacturing apparatus for a glass sheet.

FIG. 2 is a sectional view for illustrating a cross section taken along the line A-A in FIG. 1.

FIG. 3 is a sectional view for illustrating a cross section taken along the line B-B in FIG. 1 and showing a state before a preparation step.

FIG. 4 is a sectional view showing a state during the preparation step.

FIG. 5 is a plan view for illustrating a curving mechanism.

FIG. 6 is a sectional view for illustrating a breaking step.

### DESCRIPTION OF EMBODIMENTS

Hereinafter, a manufacturing method and manufacturing apparatus for a glass sheet according to an embodiment are described with reference to the accompanying drawings. X, Y, and Z directions in the drawings referred to in the description of the embodiment are orthogonal to each other. The Y direction corresponds to the vertical direction.

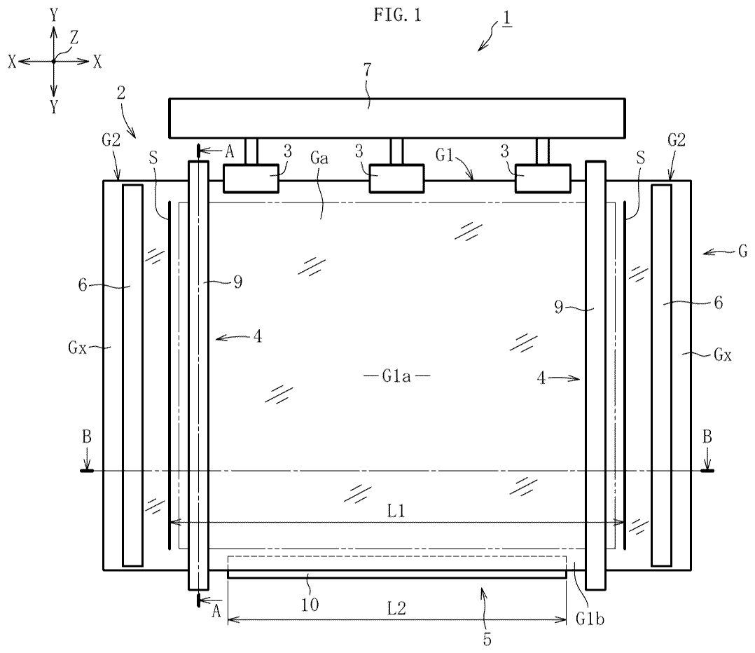

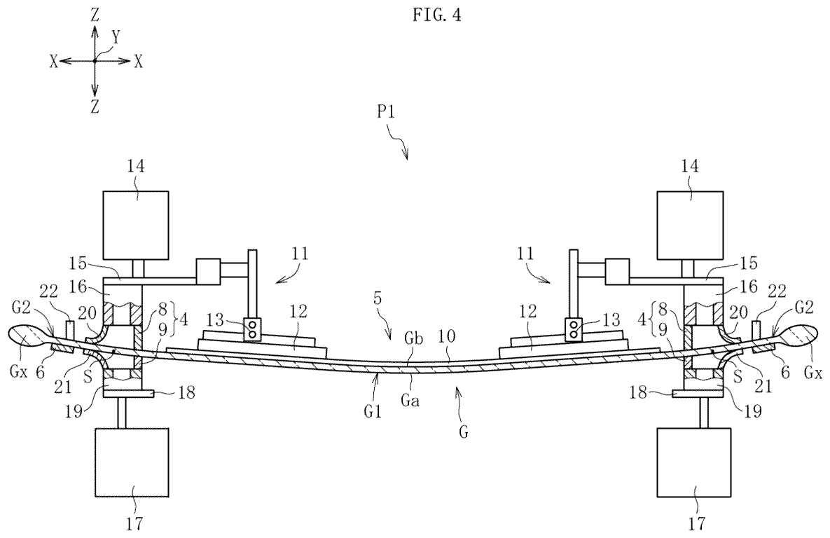

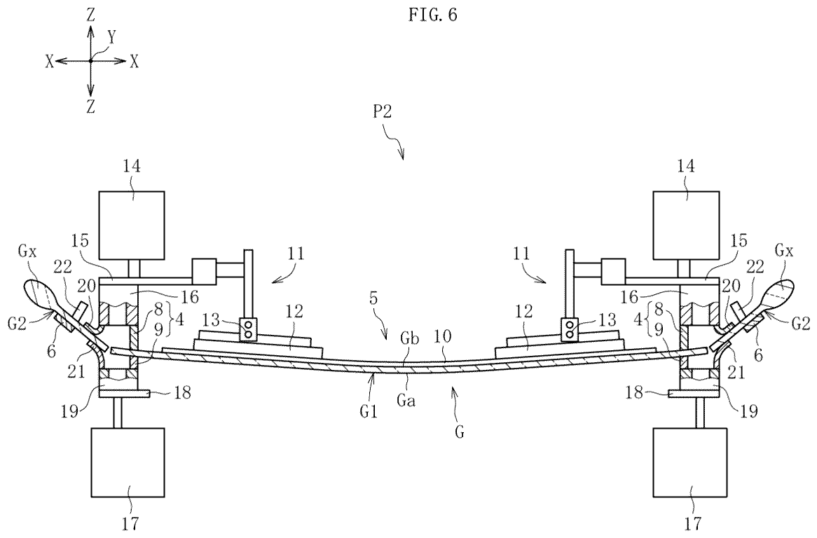

FIG. 1 shows a manufacturing apparatus 1 for a glass sheet (hereinafter referred to simply as “manufacturing apparatus 1”). In the manufacturing method for a glass sheet using this manufacturing apparatus 1, a breaking step P2 (see FIG. 6) is conducted. In the breaking step P2, a glass sheet G being in a vertical orientation, which has scribe lines S formed on a front surface Ga and extending in a vertical direction (Y direction), is broken. The manufacturing method comprises the above-mentioned breaking step P2 and a preparation step P1 (see FIG. 4) of achieving a state ready for breaking the glass sheet G. After the preparation step P1, the breaking step P2 is conducted to break the glass sheet G. In the preparation step P1, the glass sheet G before breaking is curved such that the front surface Ga is shaped into a convex curved surface in a cross section parallel to a horizontal direction (X direction).

The glass sheets G, which are to be broken, are glass sheets G successively cut out from a glass ribbon formed by a down-draw method (for example, an overflow down-draw method) by cutting the glass ribbon into pieces, each having a predetermined length. A plurality of glass sheets G cut out from the glass ribbon are conveyed in order into the manufacturing apparatus 1 and are broken therein.

The glass sheet G has a rectangular shape. A dimension of the glass sheet G in the horizontal direction is, for example, 1,500 mm or more and 3,500 mm or less, and a dimension of the glass sheet G in the vertical direction is, for example, 1,500 mm or more and 3,500 mm or less. The glass sheet G has thickened edge portions Gx, which are formed at the time of forming the glass ribbon, as both end portions of the glass sheet G in the horizontal direction. The thickened edge portions Gx each have a larger thickness as compared to the other area of the glass sheet G. The glass sheet G has flexibility. The thickness of the glass sheet G (thickness of the area other than the thickened edge portions Gx) is from 150 μm to 2,000 μm as one example.

The scribe lines S are formed, one on each side of the glass sheet G in the horizontal direction. The scribe lines S serve as a boundary between a first region G1 and each second region G2 of the glass sheet G. The first region G1 and each of the second regions G2 are adjacent to each other in the horizontal direction across the scribe line S. In this embodiment, the glass sheet G has the second regions G2 on both sides of the first region G1 in the horizontal direction. Along with the breaking step P2, the first region G1 and the second regions G2 are separated from each other, and the second regions G2 are discarded as unnecessary portions. A dimension of the second region G2 in the horizontal direction is, for example, 20 mm or more and 700 mm or less.

The first region G1 of the glass sheet G comprises: a usable portion G1a, which is a portion to be a product glass sheet later; and an unusable portion G1b, which is a non-product glass sheet portion to be removed. In FIG. 1, a boundary between the usable portion G1a and the unusable portion G1b is indicated by a two-dot-dash line. The usable portion G1a is positioned in a center of the first region G1, and the unusable portion G1b is positioned so as to surround the usable portion G1a. The unusable portion G1b is a portion to be removed by cutting in a later step. A width of the unusable portion G1b is, for example, 200 mm or less. Meanwhile, a glass sheet formed of the usable portion G1a, which is cut out in the later step, is divided into a plurality of glass sheets through cutting, as required. Further, the glass sheet formed of the usable portion G1a is subjected to an end-surface finishing treatment with a grindstone, a cleaning treatment, an inspection process, and the like to be a product glass sheet. Such a product glass sheet is used as, for example, a glass substrate for a display.

The manufacturing apparatus 1 comprises a breaking mechanism 2 configured to perform the preparation step P1 and the breaking step P2.

The breaking mechanism 2 comprises, as main components: holding members 3; support members 4; a curving mechanism 5; and pushing members 6. The holding members 3 hold an upper part (upper side portion) of the glass sheet G to suspend the glass sheet G. The support members 4 support one end portion and the other end portion of the first region G1 in the horizontal direction from both front and back sides. The curving mechanism 5 is configured to perform the preparation step P1. The pushing members 6 push the second regions G2 from the front surface Ga side so that areas around the scribe line S are curved so as to form a convex shape on the front surface Ga side, in the breaking step P2 after the preparation step P1.

A plurality of (three in this embodiment) holding members 3 are arranged along an upper part of the first region G1 of the glass sheet G. The holding members 3 in this embodiment are chucks that grip the upper part of the first region G1 from both the front and back sides. The chucks grip the unusable portion G1b of the first region G1. Suction pads that hold by suction the front surface Ga or the back surface Gb of the upper part of the first region G1 may be used as the holding members 3. In this case, the unusable portion G1b of the first region G1 is held by suction of the suction pads.

A plurality of holding members 3 are coupled to a traveling body 7. The traveling body 7 can travel along a rail (not shown) extending in the X direction. Along with the travel of the traveling body 7 along the rail, the glass sheet G before the preparation step P1 is conveyed into the manufacturing apparatus 1, and the first region G1 after the breaking step P2 (the glass sheet G from which the second regions G2 have been removed) is conveyed out of the manufacturing apparatus 1.

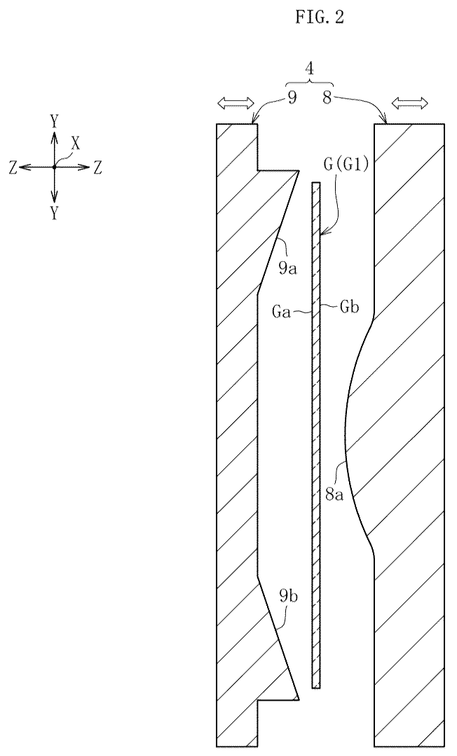

The support members 4 extend in the vertical direction and can support the first region G1 over its full length in the vertical direction. As illustrated in FIG. 2, each of the support members 4 comprises a fulcrum member 8 and a retaining member 9. The fulcrum member 8 is arranged on the back surface Gb side of the glass sheet G. The retaining member 9 is arranged on the front surface Ga side of the glass sheet G so as to oppose the fulcrum member 8 across the glass sheet G.

The fulcrum member 8 and the retaining member 9 can be moved in the Z direction (thickness direction of the glass sheet G) as indicated by the arrows in FIG. 2. Before the preparation step P1, the fulcrum member 8 and the retaining member 9 are retracted from the glass sheet G (state illustrated in FIG. 2). When the preparation step P1 is started, the fulcrum member 8 and the retaining member 9 are moved forward toward the glass sheet G to clamp and support the first region G1 from both the front and back sides. The fulcrum member 8 and the retaining member 9 continuously support the first region G1 until the completion of the breaking step P2. After the breaking step P2, the fulcrum member 8 and the retaining member 9 are retracted from the glass sheet G and release the support for the first region G1.

The fulcrum member 8 is a member that contacts the first region G1 from the back surface Gb side. The fulcrum member 8 serves as a fulcrum at the time when the pushing member 6 curves the area around the scribe line S to form a convex shape on the front surface Ga side. The retaining member 9 is a member that contacts the first region G1 from the front surface Ga side, to retain the first region G1 so as to prevent the first region G1 from separating from the fulcrum member 8 at the time when the pushing member 6 curves the area around the scribe line S. A distance between the fulcrum member 8 and the scribe line S and between the retaining member 9 and the scribe line S in the X direction is, for example, from 10 mm to 60 mm.

The fulcrum member 8 comprises an intermediate protruding portion 8a in a central portion of an area facing the glass sheet G. The intermediate protruding portion 8a is smoothly curved such that its projecting length gradually decreases from a center toward both ends in the vertical direction. A length of the intermediate protruding portion 8a in the vertical direction is from one-quarter to three-quarters of a length of the glass sheet G in the vertical direction. The intermediate protruding portion 8a is positioned below the holding members 3 that hold the upper part of the glass sheet G. A contact area of the fulcrum member 8 that contacts the glass sheet G, which comprises the intermediate protruding portion 8a, is elastically deformable and is formed of a porous resin typified by a sponge or a low-resilience sponge, a foamed resin, or the like. A lower limit value of the projecting length of the intermediate protruding portion 8 a is preferably 10 mm or more. An upper limit value of the projecting length of the intermediate protruding portion 8 a is preferably 300 mm or less, more preferably 100 mm or less.

The retaining member 9 comprises: an upper protruding portion 9a on an upper part of an area facing the glass sheet G; and a lower protruding portion 9b on a lower part. Both of the upper protruding portion 9a and the lower protruding portion 9b have a projecting length gradually increasing from a center toward both ends in the vertical direction. The upper protruding portion 9a and the lower protruding portion 9b are both arranged at such positions as not to overlap the intermediate protruding portion 8a of the fulcrum member 8 in the vertical direction. Further, the upper protruding portion 9a is arranged at such a position as to overlap the holding members 3 holding the upper part of the glass sheet G in the vertical direction. A contact area of the retaining member 9 that contacts the glass sheet G, which comprises the upper protruding portion 9a and the lower protruding portion 9b, is elastically deformable and is formed of a porous resin typified by a sponge or a low-resilience sponge, a foamed resin, or the like. A lower limit value of a projecting length of each of the upper protruding portion 9a and the lower protruding portion 9b is preferably 10 mm or more. An upper limit value of the projecting length of each of the upper protruding portion 9a and the lower protruding portion 9 b is preferably 300 mm or less, more preferably 100 mm or less.

The fulcrum member 8 and the retaining member 9, each having the configuration described above, allow an area of the first region G1 clamped between the fulcrum member 8 and the retaining member 9 from both the front and back sides (one end portion and the other end portion of the first region G1 in the horizontal direction) to be curved such that the front surface Ga is shaped into a convex curved surface in a cross section parallel to the vertical direction.

As illustrated in FIG. 1, the curving mechanism 5 comprises a pressing member 10 that presses a lower part (lower side portion) of the first region G1 of the glass sheet G from the back surface Gb side. The pressing member 10 presses the lower part of the first region G1 between the support member 4 on one side and the support member 4 on the other side in the horizontal direction. The pressing member 10 has an elongated shape extending in the horizontal direction. The pressing member 10 is configured to contact only the unusable portion G1b out of the usable portion G1a and the unusable portion G1b of the first region G1.

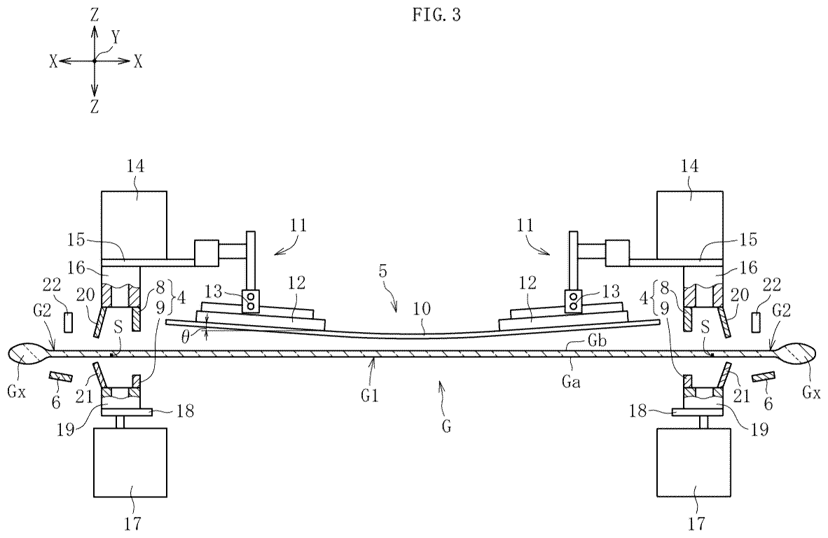

FIG. 3 shows a state before the preparation step P1, and FIG. 4 shows a state during the preparation step P1. As is understood from both of the drawings, the pressing member 10 can be moved in the Z direction. Before the preparation step P1, the pressing member 10 is retracted from the glass sheet G. When the preparation step P1 is started, the pressing member 10 is moved forward toward the glass sheet G and presses the lower part of the first region G1 to curve the glass sheet G before breaking such that the front surface Ga is shaped into a convex curved surface in the cross section parallel to the horizontal direction. After the breaking step P2, the pressing member 10 is retracted from the glass sheet G and releases the pressing on the lower part of the first region G1.

The pressing member 10 is curved so as to gradually project toward the glass sheet G as being closer toward the center in the horizontal direction. The pressing member 10 is an elastically deformable plate arranged in a vertical orientation, and is formed of, for example, a resin plate. The pressing member 10 has higher stiffness than the glass sheet G. When the pressing member 10 is configured to contact the glass sheet G, the glass sheet G is deformed.

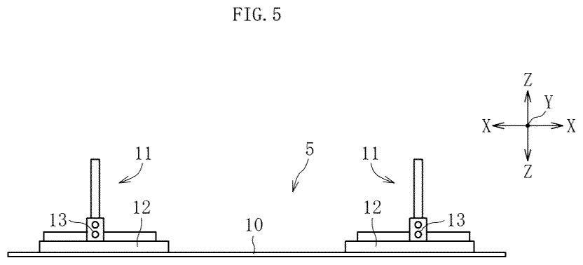

The pressing member 10 is held by two arms 11. Each of the arms 11 is provided with a holder 12 configured to hold the pressing member 10. When the holder 12 is rotated about a point 13 illustrated in FIG. 3 and FIG. 4, an inclination θ with respect to the X direction can be adjusted. For example, a screw is provided at the point 13. The inclination θ is preferably set to 30° or less. The adjustment of the inclination e enables adjustment of a curvature at which a contact portion (surface of the resin plate) of the pressing member 10 that contacts the first region G1 is curved in the cross section parallel to the horizontal direction. The term “curvature” as used herein refers to a curvature of an area of the pressing member 10, which is positioned between the holder 12 on one side and the holder 12 on the other side. Along with the adjustment of the curvature, a curvature of the front surface Ga of the glass sheet G, which has been shaped into a convex curved surface, can be changed. Instead of being curved, the pressing member 10 can be extended straight by setting the inclination θ to 0° (see FIG. 5).

A proportion of a horizontal-direction dimension L2 of the pressing member 10 to a horizontal-direction dimension L1 of the first region G1 (L1 and L2 are indicated in FIG. 1) is preferably set to 60% or more. The proportion is set as described above in view of suitably preventing generation of vibrations propagating from the lower part of the glass sheet G at the time of breaking and in view achieving the same curvature of curves in a cross section of the glass sheet G, which is parallel to the horizontal direction, as much m as possible at the time of breaking when a plurality of glass sheets G are successively broken in the manufacturing apparatus 1.

The two arms 11 are coupled to drive units 14, respectively. The drive unit 14 coupled to one of the two arms 11 and the drive unit 14 coupled to the other one thereof are configured to operate in synchronization. linear-motion mechanism comprising a combination of a cylinder or a ball screw and a linear guide as one example is built in each of the drive units 14, 14. A plate 15 provided to the arm 11 is moved in the Z direction by using the linear-motion mechanism. Along with the movement of the plate 15 in the Z direction, the pressing member 10 is moved in the Z direction.

The fulcrum member 8 is mounted to the plate 15 through a dust collector 16. The advancing operation of the fulcrum member 8 toward the glass sheet G and the retracting operation of the fulcrum member 8 from the glass sheet G, which have been described above, are performed along with the movement of the plate 15 in the Z direction. Further, the fulcrum member 8 and the pressing member 10 are coupled to the same plate 15. Thus, the fulcrum member 8 and the pressing member 10 are moved in synchronization in the Z direction. That is, the fulcrum member 8 and the pressing member 10 are moved together as a unit in the Z direction. Positions of the fulcrum member 8 and the pressing member 10 in the Z direction are not always required to match each other. Timings at which the fulcrum member 8 and the pressing member 10 come into contact with the glass sheet G can be adjusted by changing the positions of the fulcrum member 8 and the pressing member 10 in the Z direction.

Two drive units 17, each having a structure similar to that of the drive unit 14 described above, are arranged on the front surface Ga side of the glass sheet G. The two drive units 17, 17 are configured to operate in synchronization. Each of the drive units 17, 17 can move a plate 18 in the Z direction. The retaining member 9 is mounted to the plate 18 through a dust collector 19. The advancing operation of the retaining member 9 toward the glass sheet G and the retracting operation of the retaining member 9 from the glass sheet G, which have been described above, are performed along with the movement of the plate 18 in the Z direction. The drive unit 17 operates in synchronization with the drive unit 14 described above, and the retaining member 9 is moved in synchronization with the fulcrum member 8 and the pressing member 10 in the Z direction. That is, an operation in which the support member 4 (the fulcrum member 8 and the retaining member 9) supports the first region G1 and an operation in which the pressing member 10 presses the first region G1 are synchronized.

The dust collectors 16 and 19 comprise cover members 20 and 21, respectively. Each of the cover members 20 and 21 has flexibility. The cover members 20 and 21 can be deformed along the front surface Ga or the back surface Gb when in contact with the glass sheet G. Thus, the cover members 20 and 21 are configured to close a space around the scribe line S on the glass sheet G in cooperation with the dust collectors 16 and 19, the fulcrum member 8, and the retaining member 9. The dust collectors 16 and 19 can draw in glass powder generated at the time of breaking of the glass sheet G and collect the glass powder from the closed space.

The pushing member 6 is formed in a plate-like shape extending in the vertical direction as one example. The pushing member 6 can be moved in the Z direction. Along with the movement of the pushing member 6 in the Z direction, the second regions G2 are pushed from the front surface Ga side toward the back surface Gb side at the time of breaking of the glass sheet G.

A suction member 22 is arranged at such a position as to be opposed to the pushing member 6 across the glass sheet G (the second region G2). The suction member 22 comprises an array of a plurality of suction pads arranged in the vertical direction as one example. The suction member 22 is configured to hold the second region G2 after separation by suction of the back surface Gb of the second region G2 before, throughout, and after breaking.

Hereinafter, a flow of the preparation step P1 and the breaking step P2 that are conducted using the above-mentioned manufacturing apparatus 1 is described.

First, along with the travel of the traveling body 7, the glass sheet G, which is suspended in a vertical orientation by the holding members 3, is conveyed into the manufacturing apparatus 1. After the completion of conveyance of the glass sheet G into the manufacturing apparatus 1, a state illustrated in FIG. 1 and FIG. 3 is achieved. Under this state, the preparation step P1 is started.

In the example illustrated in FIG. 3, the glass sheet G is formed flat in the horizontal direction. However, the glass sheet G may have such a warp that has deformed the front surface Ga into a convex curved surface in the cross section parallel to the horizontal direction or the glass sheet G may have such a warp that has deformed the back surface Gb into a convex curved surface in the cross section parallel to the horizontal direction, depending on a thermal history of the glass sheet G. The term “warp” as used herein does not refer to a warp generated as a result of application of an external force to the glass sheet G, but refers to a warp inherent in the glass sheet G.

In the preparation step P1, both of the drive units 14, 14 and both of the drive units 17, 17 are operated to move the fulcrum members 8, the retaining members 9, and the pressing member 10 forward toward the glass sheet G. As a result, the first region G1 of the glass sheet G is clamped between the fulcrum members 8 and the retaining members 9 from both the front and back sides so as to be supported therebetween. At the same time, the lower part of the first region G1 is pressed from the back surface Gb side to curve the glass sheet G before breaking so that the front surface Ga is shaped into a convex curved surface in the cross section parallel to the horizontal direction. In this manner, a contact state between the fulcrum members 8 and the glass sheet G is stabilized. Further, spaces around the scribe lines S are closed by the cover members 20 and 21, and the like. In addition, the pushing members 6 are brought into contact with the front surfaces Ga of the second regions G2, while the back surfaces Gb of the second regions G2 are held by suction of the suction members 22. After the preparation step P1 is completed, a state illustrated in FIG. 4 is achieved.

Here, when the glass sheet G has such a warp that has deformed the back surface Gb into a convex curved surface in the cross section parallel to the horizontal direction as described above, the front surface Ga of the glass sheet G is a concave curved surface in the cross section parallel to the horizontal direction before the preparation step P1 is conducted. Thus, A convex/concave orientation of the front and back surfaces of the glass sheet G in the cross section parallel to the horizontal direction is switched after the preparation step P1. Meanwhile, when the glass sheet G has such a warp that has deformed the front surface Ga into a convex curved surface in the cross section parallel to the horizontal direction, the convex/concave orientation of the front and back surfaces in the cross section parallel to the horizontal direction is not switched after the preparation step P1. That is, with the preparation step P1, even when the glass sheet G has such a warp that has deformed either the front surface Ga or the back surface Gb into a convex curved surface in the cross section parallel to the horizontal direction, the same curved state of the glass sheet G in the cross section parallel to the horizontal direction can be obtained after the preparation step P1.

After the preparation step P1 is completed, the breaking step P2 is started to break the glass sheet G, which has been curved to have a convex curved surface through the preparation step P1, along the scribe lines S. Specifically, the second regions G2 are pushed by the pushing members 6 from the front surface Ga side under a state in which the back surfaces Gb of the second regions G2 are held by suction of the suction members 22. As a result, each of the areas around the scribe lines S is curved so that the front surface Ga is shaped convex around the fulcrum member 8 as a fulcrum, and the glass sheet G is broken under bending stress. The second regions G2 after separation are held by the suction members 22 and are discarded to a predetermined discard position. The glass powder generated at the time of breaking is collected by the dust collectors 16 and 19. Through the above-mentioned process, the breaking step P2 is completed to separate the first region G1 and the second regions G2 from each other as illustrated in FIG. 6.

Here, a modification example as described below can also be applied to the embodiment described above.

In the embodiment described above, the lower part (lower side portion) of the first region G1 of the glass sheet G is pressed by the pressing member 10. However, a position to be pressed is not limited thereto. An area above the lower part of the first region G1 may be pressed by the pressing member 10. Also in this case, however, it is preferred that the unusable portion G1b be pressed by the pressing member 10 in view of prevention O f a scratch on and contamination of f the usable portion G1a.

In the embodiment described above, a lower end of the pressing member 10 is located below the lower end (lower edge portion) of the glass sheet G. However, a position of the lower end of the pressing member 10 is not limited thereto. The lower end of the pressing member 10 may be located above the lower end of the glass sheet G.

In the embodiment described above, the areas of the first region G1 (one end portion and the other end portion of the first region G1 in the horizontal direction), which are sandwiched between the support members 4 (the fulcrum members 8 and the retaining members 9) from both the front and back sides, are curved such that the front surface Ga is shaped into a convex curved surface in the cross section parallel to the vertical direction. However, the shape of the first region G1 is not limited thereto. Areas of the support members 4, which face the glass sheet G, may be formed substantially parallel to the vertical direction so that the areas of the first region G1, which are sandwiched between the support members 4 from both the front and back sides, are not curved in the cross section parallel to the vertical direction.

In the embodiment described above, the operation in which the support members 4 (the fulcrum members 8 and the retaining members 9) support the first region G1 and the operation in which the pressing member 10 presses the first region G1 are synchronized. However, the operations are not limited thereto. The pressing member 10 may start pressing the first region G1 after the support members 4 start supporting the first region G1, or the support members 4 may start supporting the first region G1 after the pressing member 10 starts pressing the first region G1.

In the embodiment described above, the plate (resin plate) is used as the pressing member 10. However, the pressing member 10 is not limited thereto. A member other than a plate may be used as the pressing member 10 as long as the contact portion of the pressing member 10 that contacts the glass sheet G is curved so as to gradually project toward the glass sheet G as being closer toward the center in the horizontal direction. However, a member capable of adjusting the curvature of the curve is preferred.

### REFERENCE SIGNS LIST

1 manufacturing apparatus for glass sheet
2 breaking mechanism
3 holding member
4 support member
5 curving mechanism
10 pressing member
G glass sheet
G1 first region
G1a usable portion
G1b unusable portion
G2 second region
Ga front surface
Gb back surface
P1 preparation step
P2 breaking step
S scribe line

1. A manufacturing method for a glass sheet, the method comprising a breaking step of breaking the glass sheet being in a vertical orientation and having a scribe line formed on a front surface and extending in a vertical direction, to separate a first region and a second region which are adjacent to each other in a horizontal direction across the scribe line as a boundary,
the method further comprising a preparation step of curving the glass sheet before breaking such that the front surface is shaped into a convex curved surface in a cross section parallel to the horizontal direction,
wherein, after the preparation step, the breaking step is conducted on the glass sheet in a curved state.

2. The manufacturing method for a glass sheet according to claim 1, wherein, in the preparation step, the glass sheet is pressed from a back surface side by a pressing member.

3. The manufacturing method for a glass sheet according to claim 2,
wherein the glass sheet has the second regions on both sides of the first region in the horizontal direction, and
wherein the preparation step comprises:
holding an upper part of the glass sheet with a holding member so that the glass sheet is suspended; and
pressing a lower part of the first region with the pressing member.

4. The manufacturing method for a glass sheet according to claim 3,
wherein the first region comprises:
a usable portion that is to become a product; and
an unusable portion that is to become a non-product, and
wherein, in the preparation step, the pressing member is brought into contact with only the unusable portion out of the usable portion and the unusable portion.

5. The manufacturing method for a glass sheet according to claim 3,
wherein, in the preparation step, while causing support members to support one end portion and the other end portion of the first region in the horizontal direction from both front and back sides, and while causing the pressing member to press the lower part of the first region between the support members that support the one end portion and the other end portion,
an operation in which the support members support the first region and an operation in which the pressing member presses the first region are synchronized.

6. The manufacturing method for a glass sheet according to claim 3,
wherein the pressing member extends in the horizontal direction, and
wherein, with respect to a contact portion of the pressing member that contacts the glass sheet, a curvature of the contact portion in the cross section parallel to the horizontal direction is adjustable.

7. The manufacturing method for a glass sheet according to claim 1, wherein, in the preparation step, the glass sheet before breaking is curved such that the front surface is shaped into a convex curved surface in a cross section parallel to the vertical direction.

8. A manufacturing method for a glass sheet, the method comprising a breaking step of breaking the glass sheet being in a vertical orientation and having a scribe line formed on a front surface and extending in a vertical direction, to separate a first region and a second region which are adjacent to each other in a horizontal direction across the scribe line as a boundary,
wherein the glass sheet has the second regions on both sides of the first region in the horizontal direction,
wherein the manufacturing method further comprises a preparation step of achieving a state ready for breaking the glass sheet, the preparation step being followed by the breaking step conducted on the glass sheet in a curved state, and
wherein, in the preparation step, an upper part of the glass sheet is held by a holding member so that the glass sheet is suspended, and a lower part of the first region is pressed from a back surface side by a pressing member.

9. A manufacturing apparatus for a glass sheet, the manufacturing apparatus comprising a breaking mechanism configured to break the glass sheet being in a vertical orientation and having a scribe line formed on a front surface and extending in a vertical direction, to separate a first region and a second region which are adjacent to each other in a horizontal direction across the scribe line as a boundary,
wherein the breaking mechanism comprises a curving mechanism configured to curve the glass sheet before breaking such that the front surface is shaped into a convex curved surface in a cross section parallel to the horizontal direction.

10. A manufacturing apparatus for a glass sheet, the manufacturing apparatus comprising a breaking mechanism configured to break the glass sheet being in a vertical orientation and having a scribe line formed on a front surface and extending in a vertical direction, to separate a first region and a second region which are adjacent to each other in a horizontal direction across the scribe line as a boundary,
wherein the glass sheet has the second regions on both sides of the first region in the horizontal direction, and
wherein the breaking mechanism comprises:
a holding member configured to hold an upper part of the glass sheet to suspend the glass sheet; and
a pressing member configured to press a lower part of the first region from a back surface side.
